(19) United States
(12) Patent Application Publication
(10) Pub. No.: US 2016/0350801 A1
(43) Pub. Date: Dec. 1, 2016

(54) METHOD FOR ANALYSING COMPREHENSIVE STATE OF A SUBJECT

(71) Applicants: Albert Charles VINCENT, Petaling Jaya (MY); Mohammed Imran AKTHAR, Secunderbad (IN); Theenathayalan PARTHASARATHY, Bangalore (IN)

(72) Inventors: Albert Charles VINCENT, Petaling Jaya (MY); Mohammed Imran AKTHAR, Secunderbad (IN); Theenathayalan PARTHASARATHY, Bangalore (IN)

(21) Appl. No.: 15/161,765

(22) Filed: May 23, 2016

(30) Foreign Application Priority Data
May 29, 2015 (MY) PI 2015701754

(51) Int. Cl. G06Q 30/02; G06K 9/00; G10L 15/02; G06N 99/00

(52) U.S. Cl. CPC G06Q 30/0251; G06N 99/005; G06K 9/00335; G06K 9/00302; G10L 15/02

(57) ABSTRACT

The invention discloses a method for obtaining comprehensive state of a subject. The comprehensive state of the subject includes the emotional states of the subject and the dynamic profile states of the subject. The method for obtaining the comprehensive state of the subject includes the steps of obtaining the emotional state of the subject by multimodal emotion recognition and obtaining a multi dimensional dynamic profile state of the subject. The emotional states and multi dimensional dynamic profile states of the subject is then combined using a machine learning application for identifying the comprehensive state of the subject.

This application claims benefit of Serial No. PI 2015701754, filed 29 May 2015 in Malaysia and which application is incorporated herein by reference. To the extent appropriate, a claim of priority is made to the above disclosed application.

### FIELD OF INVENTION

The present invention relates to the field of analyzing comprehensive state or status of a subject, and more particularly, to the methods of analyzing or obtaining comprehensive state of a subject that includes emotional state and profile of the subject.

### BACKGROUND

Providing targeted advertisements to users through computer systems and other digital means is well known in the art. Conventional advertising systems are based on the data associated with the users including the location and other data including historical and current search queries of the user. When a user enters a search query in a web browser executing on the user's computer, the search engine provides search results along with several advertising contents. Advertisers may bid on the search query to have their advertisements included in a search results page that is transmitted from the search engine to the user's computer. The conventional advertisement system depends on the search keywords, browser cookies, browsing history, time, location, etc., of the user for providing appropriate advertisement contents. However, the conventional advertisement systems may not be able to provide appropriate advertisement contents based on the emotional states and user profile of the user.

A more advanced method uses emotional states of the user for providing targeted advertisements to users. An emotional state may be detected by using a variety of sensors, using electronic devices including camera for analyzing the facial features of the user, microphone for analyzing the emotional contents in the voice of the user, activities of the user with various electronic devices including mouse or keyboard of a computer, touch screen of a smartphone, tablet, by analyzing user's posture, analysis of digital data relevant to a user, etc. Further analyzing the biomedical data of the user for example, heart rate, anxiety level, etc., also provides the emotional states of the user. These emotional states of the user collected using the devices and sensors have been widely used for providing targeted advertising contents to the user. Also users may have personal differences in the way they express emotions. For example, one user may be more introverted and another more extraverted. Most modern methods and business analytics systems takes the personal differences into account when analyzing the emotional states of users. Existing systems may use a learning algorithm to learn how a specific user typically exhibits specific emotions, and may build a user profile regarding the way emotional states are exhibited by the user.

US patent application US 2012/0143693 A1 filed by Microsoft Corporation discloses a computer implemented system and method to determine emotional states of users and to provide targeted advertisements on the user's devices based on the detected emotional states of the users. The computer implemented method includes the steps of monitoring and processing the users' online activity for a particular time period to identify a tone associated with a content presented to the user, thereafter receiving an indication of the user's reaction to the content and assigning an emotional state to the user based on the tone of the content and the indication of the user's reaction to the content. The online activity of the user includes the browsing history, webpage content, search queries, emails, instant messages, and online games that the user interacts with and the user's reaction to the content is identified from facial expressions, speech patterns, gestures and body movements of the user captured using multiple devices. The above application collects the user's reaction to the online content by way of analyzing body movement, speech patterns and facial expression using webcams and microphones associated with a computer or collects the voice and gestures from the computing devices such as Microsoft Kinect for detecting the emotional states of the user for the particular period and can be used to provide targeted advertisements to the user's devices. However, the computer implemented system of the above disclosed application depends only on the emotional responses of the user for a particular content to provide targeted contents to the user's devices. The above disclosed application does not collect the profile information of the users for providing targeted contents and in most cases detecting the emotional state of the users for providing targeted advertisements is inadequate to provide suitable advertising contents to different users.

US patent application US 2014/0112556 A1 filed by Sony Computer Entertainment Inc. discloses an apparatus and an associated method for determining an emotional state of a user. The method includes the steps of extracting acoustic features, visual features, linguistic features and physical features from signals obtained by one or more sensors, thereafter analyzing these features using one or more machine learning algorithms and extracting an emotional state of the user from analysis of the features. The emotional states obtained from the analysis of the features of the user can be used as an input to a game or other machine to dynamically adapt the response of the game or other machine based on the player's or user's emotions. However, the above application does not disclose anything about using the emotional states of the user for providing targeted advertising contents to the user's devices. In addition, the above disclosed application does not collect the profile information of the users for providing targeted contents to the users.

Existing systems and methods for detecting the emotional state of the user for providing targeted advertisements is sometimes not accurate and inadequate to provide suitable advertisements to different users. Existing systems and methods only detects and analyzes the emotional states of the user for providing targeted advertisements or certain profile information of the user including age, gender, etc. for the targeted advertisements. Hence there exists a need for more advanced and accurate method of detecting both emotional states of the user and a wide variety of profile state of the user for providing targeted advertisements to the users through multiple electronic devices. The present invention would be able to collect the comprehensive states of the users including their emotional and profile status information of the users for providing targeted contents to their respective devices.

### SUMMARY

The present invention is a method for obtaining at least one comprehensive state of a subject. The comprehensive state of the subject includes the deep emotional states of the subject and the dynamic profile states of the subject. The comprehensive state of a subject obtained using the present method can be utilized for a number of applications, for example, the comprehensive state of the subject can be used for dynamically updating business analytics and thereby providing tailored contents to the subject. The method for obtaining the comprehensive state of the subject includes the step of performing comprehensive multimodal emotion recognition to determine the deep emotional states of the subject and obtaining a multi dimensional dynamic profile state of the subject. The method of performing the comprehensive multimodal emotion recognition of the subject comprises the steps of monitoring a number of features including facial emotion, speech emotion and body language features of the subject using a number of sensors. The collected features of the subject such as the facial features, speech features and body language features are automatically classified based on instructions of a machine-learning program executed using a computer system. The information received after classification of the features is then processed using a first local fusion program based on a fusion algorithm to determine the emotional states of the subject. The multi dimensional dynamic profile state of the subject is obtained by collecting, integrating, processing and analyzing multiple profile state information from homogeneous and heterogeneous sources including social media interactions, facial recognition, global and local events and geopolitical events, financial information, brand affinity, personal preferences, scene analysis, age and gender estimation, professional history, purchase history, navigation traces on web, location history, weather data, event calendar, pre-event and post event status, medical health data, email, subject's family information, subject's psychological information, subject's social connections information, subject's contacts' information, subject's wearable information, subject's physical appearance, subject's crime history, academics data, subject's surroundings information, any other commodities purchased and/or used by the subject, any other information directly or indirectly related to the subject and accessible through the Internet and any other data generated and/or consumed by the subject. The above profile state information associated with the subject are processed based on instructions of a second local fusion program to obtain the multi dimensional dynamic profile state of the subject. The multi dimensional dynamic profile state of the subject and the multimodal emotion recognition information related to the emotional state of the subject in response to the content is processed using a global fusion program to obtain the comprehensive state of the subject.

Other objects and advantages of the embodiments herein will become readily apparent from the following detailed description taken in conjunction with the accompanying drawings.

### BRIEF DESCRIPTIONS OF THE DRAWINGS

FIG. 1A illustrates a block diagram showing a method of performing the multimodal emotion recognition of a subject, according to a preferred embodiment of the present invention;

FIG. 1B illustrates a block diagram showing the method of performing the multimodal emotion recognition of the subject using classifiers and local fusion algorithm, according to a preferred embodiment of the present invention;

FIG. 2 illustrates a block diagram showing a method of detecting a multi-dimensional dynamic profile state of the subject, according to a preferred embodiment of the present invention;

FIG. 3 shows a block diagram of a machines learning program for processing the multidimensional dynamic profile state information and the multimodal emotion recognition information for obtaining a comprehensive state of the subject;

FIG. 4 illustrates a block diagram showing a computer-implemented system for obtaining the at least one comprehensive state of the subject;

FIG. 5 illustrates a flow diagram showing a computer-implemented system for obtaining the targeted advertisements and business services for the subject based on the emotional state and the profile states of the subject; and

FIG. 6 illustrates a flowchart showing the method for providing the targeted advertisements and business services by continuously updating the business analytics based on the comprehensive state of the subject.

### DETAILED DESCRIPTION

In the following description, numerous specific details are set forth. However, it is to be understood that the embodiments of the invention may be practiced without these specific details. In other instances, well-known hardware, software and programming methodologies have not been shown in detail in order not to obscure the understanding of this description. In this description, references to “one embodiment” or “an embodiment” mean that the feature being referred to is included in at least one embodiment of the invention. Moreover, separate references to “one embodiment” in this description do not necessarily refer to the same embodiment; however, neither are such embodiments mutually exclusive, unless so stated and except as will be readily apparent to those of ordinary skill in the art. Thus, the invention may include any variety of combinations and/or integrations of the embodiments described herein. The embodiments are described in sufficient detail to enable those skilled in the art to practice the embodiments and it is to be understood that the logical, software, hardware and other changes may be made without departing from the scope of the embodiments. The following detailed description is therefore not to be taken in a limiting sense. Also herein, flow diagrams illustrate non-limiting embodiment examples of the methods; block diagrams illustrate non-limiting embodiment examples of the devices. Some of the operations of the flow diagrams are described with reference to the embodiments illustrated by the block diagrams. However, it is to be understood that the methods of the flow diagrams could be performed by embodiments of the invention other than those discussed with reference to the block diagrams, and embodiments discussed with references to the block diagrams could perform operations different than those discussed with reference to the flow diagrams. Moreover, it is to be understood that although the flow diagrams may depict serial operations, certain embodiments could perform certain operations in parallel and/or in different orders than those depicted.

Further the description provided herein is complete and sufficient for those skilled in the arts of computer systems, emotional analysis, user profile analysis, business analytics, business intelligence, etc. The embodiments of the present invention may employ computer systems, sensors, and other portable electronic devices and networkable devices such as devices connected to Internet for collecting information from at least one server or another devices connected to the network or Internet. The electronic devices, computing devices and the servers of the present invention may be running on an operating system such as Windows, Linux, or any other operating systems and at least one data processing, data retrieval, data classification application programmed using at least one computer language such as, but not limited to, C#, Java, etc. However, the invention should not be limited to these types of software, operating system or hardware.

The term “subject” refers to any living object such as human being capable of performing at least one activity such as, but not limited to, interacting with a variety of electronic devices, generating detectable emotions such as facial expressions associated with different emotions, interacting with other users through speech, text, video, etc. using an electronic device, performing any social activities, etc. Further the term “subject” refers to a person or entity that owns or otherwise possesses or operates an electronic device, capable of receiving incoming communications and initiating outgoing communications, a subscriber/service subscriber to at least one service offered through Internet, recipient or consumer or user of products and/or electronic services, etc. Further the term “subject” also refers to “user” i.e. any entity capable of exhibiting detectable emotions, such as a human being. Without limiting the scope of the invention, the term “emotional state” or “deep emotional state” as used herein refers to the a state or a combination of states of the subject such as, but not limited to, human emotions obtained from facial features of the subject including happiness, sadness, angriness, depression, frustration, agitation, fear, hate, dislike, excitement, etc., mental states and processes, such as stress, calmness, passivity, activeness, thought activity, concentration, distraction, boredom, disgust, interestedness, motivation, awareness, perception, reasoning, judgment, etc., physical states, such as fatigue, alertness, soberness, intoxication, etc. In one embodiment, an emotional state may have no explicit name and instead is obtained by combining multiple features including the facial features of the subject, speech features of the subject including linguistic tone, speech emotions such as, but not limited to, happiness, angry, excitement, like dislike, etc., body language features of the subject including body gesture emotions, and emotions of the subject obtained from the activities performed by the subject including, but not limited to, interactions with the devices, events, contents, etc. Further the term “emotional state” or “dynamic profile state” as used herein refers to the profile information of the subject collected from homogeneous and heterogeneous sources such as, but not limited to, social media interactions, facial recognition, global and local events and geopolitical events, financial history, brand likeness or brand affinity, surrounding analysis, age and gender estimation, professional history, shopping history, navigation traces on web, location history, event calendar, email of the subject and other data generated and consumed by the subject. In some other instances, the subject refers to a group of persons or crowd.

The term “facial feature” or “facial feature recognition” refers to any detectable changes or expressions, or emotions or gestures, any change in form or dimension of one or more parts of the face of the subject. For example, a mouth is a facial feature that is prone to deformation via smiling, frowning, and/or contorting in various ways. Of course, facial feature deformations are not limited to the mouth. Noses that wrinkle, brows that furrow, and eyes that widen/narrow are further examples of facial feature deformations. A facial expression also represents human emotion such as happiness, sadness, fear, disgust, surprise, anger, etc.

The term “speech feature” refers to any detectable changes or expressions produced in form of sounds by the subject. Speech feature may further include, linguistic tones, voice modulations, dialects, other audible verbal signals, etc., detectable using one or more devices, sensors, etc. In some instances, the “speech feature” includes the content of speech along with the speech emotions.

The term “body language feature” refers to the conscious and unconscious movements and postures of the subject or others by which attitudes and feelings are communicated, bodily gestures used to express emotions, actions while performing one or more activities, body posture, movement, physical state, position and relationship to other bodies, objects and surroundings, facial expression, eye movement gestures during communication to a device or another subject by using a predetermined motion pattern. For example body language feature of the subject includes how the subject position his/her body, closeness to and the space between two or more people and how this changes the facial expressions of the subject, movement of eyes and focus, etc., touch or physical interactions himself/herself and others, how the body of the subject and other people connected with the subject interact with other non-bodily things, for instance, pens, cigarettes, spectacles, clothing and other objects in the surroundings, breathing, and other less noticeable physical effects, for example heartbeat and perspiration, subject's eyes movement, focus, head movements, expression, fake expressions such as faked smile, real expressions, arms and legs positioning, subject's size, height, size of tummy, finger movement, palm orientation, or combinational movement of one or more of above and other parts, subject's breathing, perspiration, blushing, etc. Body language feature also covers the conscious and unconscious movements and postures of the subject or others under circumstances, which can produce negative feelings and signals in the subject or other people, such as, but not limited to, dominance of a boss or a teacher or other person perceived to be in authority, overloading a person with new knowledge or learning, tiredness, stress caused by anything, cold weather or cold conditions, lack of food and drink, lack of sleep, illness or disability, alcohol or drugs, being in a minority or feeling excluded, unfamiliarity, newness, change, boredom, etc. Body language feature also includes proxemics personal space between subject and others, i.e. the amount of space that people find comfortable between themselves and others thereby showing intimacy, mirrored body language between people, body language in different cultures, situations, places, etc.

The term “data sources” or “source” refers to information sources such as but not limited to information available from Internet, and through other visual sources, text and audio sources, and from other physical, and biomedical measurable devices, information obtained through wired or wireless connected devices or objects, one or more sensors, etc. The information may include data associated with a subject, other people in connection with the subject, data from environment or surroundings of the subject and others, data from devices or objects directly or indirectly associated with the subject or others, etc.

The term “emotional state” or “deep emotional state” refers to a state or a combination of states of the subject such as, but not limited to, human emotions obtained from facial features of the subject including happiness, sadness, angriness, depression, frustration, agitation, fear, hate, dislike, excitement, etc., mental states and processes, such as, but not limited to, stress, calmness, passivity, activeness, thought activity, concentration, distraction, boredom, disgust, interestedness, motivation, awareness, perception, reasoning, judgment, etc., physical states, such as fatigue, alertness, soberness, intoxication, etc. In one embodiment, an emotional state may have no explicit name and instead is obtained by combining multiple features including the facial features of the subject, speech features of the subject including linguistic tone, speech emotions such as, but not limited to, happiness, angry, excitement, like dislike, etc., body language features of the subject including body gesture and emotions of the subject obtained from the activities performed by the subject including, but not limited to, interactions with the electronic devices, events, contents, objects in the surroundings of the subject, etc. Further the term “dynamic profile state” as used herein refers to the profile information of the subject collected from homogeneous and heterogeneous sources and sensors such as, but not limited to, social media interactions, facial recognition, global and local events and geopolitical events, credit score, brand affinity, scene analysis, age and gender estimation, professional history, shopping history, navigation traces on web, location history, event calendar and email of the subject and other data generated and consumed by the subject.

The term “surroundings” refers to the environment and the objects in the environment directly or indirectly associated or not associated with the subject or one or more persons associated with the subject or other persons. For example, when the subject is in a public location such as in a restaurant or shopping center, the surroundings of the subject includes the objects in the restaurant or the shopping center, with which the subject or the persons associated with the subject or other persons may express interest towards.

The term “illness” refers to any medical condition of the subject such as, but not limited to, fever, body pain, headache, any other bodily disorders, psychological feelings, mental illness, of the subject or the persons associated with the subject or other persons, etc. This may cause one or more emotional expression on the face of the subject or the people associated with the subject or other persons. The psychological feelings refer to the mental condition of the subject or the people associated with the subject or other persons that may be either caused by the health condition of them or by other reasons. In some instances the illness also includes presence of acne, skin conditions, or other conditions, which may affect the comfort, behavior, or appearance of the subject or the people associated with the subject or other persons. The term illness further includes all the medical conditions, including internal medical conditions such as, but not limited to, lung diseases, causing breathing issues, stomach diseases, etc., and external medical conditions such as, but not limited to, skin diseases, patches, bruises, etc. of the subject.

The term “financial status” or “financial information” or “credit score” refers to all the past and present financial activities and probable future financial activities or financial conditions of the subject or the people or organization or any other entity associated with the subject. The ‘financial status’ of the subject includes, but not limited to, banking transactions, credit history, purchase history, payment information, discounts received, and other activities associated with the subject and involving cash flow or having any monetary value, etc.

The term “activities” refers to the activities performed by the subject or the people, organization, device or any other entity associated with the subject and using one ore more devices, services, objects, equipment, through any online or internet connected device or communication channel, etc. The term “activities” further includes keyboard keystroke dynamics, mouse movements, touch screen interactions, social media, geopolitical activities of the subject, and other interactions of the subject with any connected device, or any other physical activities performed by the subject indicating the emotional state of the subject.

The term “sensors” refers to measuring or data collecting devices or means such as, but not limited to, a variety of devices or means for collecting information including, but not limited to, biomedical sensors for measuring biomedical information about the subject or others associated with the subject, which includes, but not limited to, heart rate, pressure, etc., physical sensors for measuring physical activity or physical changes of the subject or others associated with the subject, sensors for measuring or monitoring changes in the environment or surroundings of the subject or others associated with the subject, sensors associated with other devices used by the subject or others associated with the subject, cameras, microphone, touch feedback sensors, etc.

The term “social media interactions” refers to interactions between the subject and the persons or entities such as organizations, groups etc., directly or indirectly associated with the subject through modern software based applications designed run on a variety of electronic devices including fixed and portable devices. These fixed and portable electronic devices includes computers, and other computer operated devices connected to a network, portable devices including Smartphone, Smart wearable devices, and other wired or wireless devices which allow direct or indirect communication for viewing, sending and receiving at least one digital content. For example, the social media interactions of the subject through Facebook application includes, comments, likes, views, shares, chats, and other activities performed directly or indirectly through the application with other subjects, and entities such as organizations, groups etc. In short, the term “social media interactions” refers to the interactions between the subject and others through any social media application such as, but not limited to, Facebook, twitter, Google plus, Gmail chat, video, voice, text chat and sharing applications, etc. and other online services enabling communication between the subject and other users associated with the subject and entities. Further, the “social media interactions” refers to the activities of the subject using social media, which includes, but not limited to, video sharing, image sharing, subscribing to one or more groups, news, publications, and any other activity performed by the subject through the social media sites and social media applications.

The term “events” or “global events”, “local events” and “geopolitical events” refers to the activities and events directly or indirectly associated with the subject, people or any other entity such as organization or any group associated with the subject, or the people associated with the subject. This may include the political or geographical changes such as change in leadership, policies, laws, etc., in the region, or region of interest of the subject, people or any other entity such as organization or any group associated with the subject. Further the term “events” or “global events”, “local events” and “geopolitical events” refers to the events that may affect the status of living, profession, and other conditions directly or indirectly affecting the subject or those related to the subject.

The term “financial information” refers to the past, present, and predictable future financial information about the movable, immovable assets of the subject, people or any other entity such as organization or any group associated with the subject. Financial information further includes all the transactions involving cash flow, credits, debits, cash reserves, etc., of the subject, people or any other entity such as organization or any group associated with the subject, other financial status of the subject, people or any other entity such as organization or any group associated with the subject. For example, the financial information such as credit score of the subject or the persons or entities associated with the subject may provide the past, current and probable future financial health of the subject or the persons or entities associated with the subject.

The term “brand affinity” refers to the products, services, companies, and others favored by the subject or the persons or entities associated with the subject. For example the subject or a person close to the subject may be an admirer of the products by companies like Apple Inc., Ralph Lauren, etc., and services from companies such as KFC, McDonald, etc.

The term “personal preferences” refers to the preferences of the subject or the persons or entities associated with the subject. For example, the subject or a close person of the subject may be an admirer of songs from certain parts of the world, special categories of songs, songs by certain artists, certain categories of books, types of sceneries, places, travelling modes, fashion preferences, personal belongings, walking styles, running styles, sleeping styles, eating styles, etc., specific types of wearable, handheld, and other electronic devices, news, subjects, other persons, companies, etc. In short, “personal preferences” refers to anything that the subject or the persons or entities associated with the subject likes or dislikes. For example personal preferences refers to person's clothing, hair style, attire, and other personal items such as suitcase, bag, computer, tablet, and other electronic devices of the person, wearable such as spectacles, watches, fitness bands, shoes, jewelry items, other personal care items, makeup products, and other consumables and commodities liked or disliked by the subject or the persons associated with the subject.

The term “medical health data” refers to the past and present medical information associated with the subject or the persons associated with the subject. This includes the all the medical diagnosis information, treatments, medicines and other health data including various external and internal health parameters of the subject or the persons associated with the subject, which includes, but not limited to, heart rate, cholesterol level, diabetes, vision, hearing, disabilities, psychological information, stress, etc.

The term “social connections information” or “contacts' information” refers to all the connections or contacts information of the subject or the persons or entities associated with the subject. This includes, the contact information obtained from the subject's or the persons or entities associated with the subject's phone, email, social media contacts, and other shared or accessible contacts information, etc.

The term “crime history” refers to all the criminal records, frauds, scandals, punishments, warnings, etc. related to the subject or the persons or entities associated with the subject.

Internet of things (IoT) refers to various devices capable of sending and receiving information via Internet, enables remote monitoring, control, etc., which may also include devices such as, but not limited to, sensors, RFID techniques, the GPS system, infrared sensors, scanners, and other various apparatus and techniques, sampling any objects or procedures to be monitored, connected or interconnected in real-time, collecting acoustical, optical, thermal, electrical, mechanical, chemical, biological, positional information and various required information, and forming a huge network in conjunction with the Internet. The IOT realize connections between objects, objects and persons, all things and networks for the convenience of identification, management and control.

It is to be understood that emotional state detection and subject's profile state information collection may be implemented by a variety of systems, methods and sensors. Moreover, the performance and characteristic of emotional state detection and profile state information collection method or algorithm may be adjusted to a specific need of a specific embodiment. For example, there may be an embodiment wherein it is preferable to operate the emotional state detection and profile state information collection according to specific conditions or at specific occasions of the subject, i.e., during specific activities the subject exhibits. Alternatively, it may be preferred to operate the emotional state detection and profile state information collection algorithm according to the different types of conditions or activities or emotional states the subject is undergoing.

The present invention is a computer-assisted method of obtaining a comprehensive state of a subject for application in plurality of fields such as targeted advertising to medical applications. The comprehensive state of the subject includes emotional states of the subject and multi dimensional dynamic profile states of the subject. In one embodiment, the comprehensive state of the subject also includes psychological state, mental state, and state of other such conditions related to a subject. In the present embodiment, the comprehensive state of the subject is determined by obtaining emotional state as well as by obtaining the multi dimensional dynamic profile state of the subject with help of a machine learning application. The emotional states of the subject are determined using a comprehensive multimodal emotion recognition program, which derives the emotional states of the subject from different emotional analysis methods. The profile states of the subject is collected from multiple homogeneous and heterogeneous sources and sensors and processed using a machine-learning program to obtain a multi dimensional dynamic profile state of the subject. The computer-assisted method of the present invention combines and processes the multiple emotional states and the multi dimensional dynamic profile states of the subject together to provide targeted business contents and other services including advertisements, business services etc. specifically targeted for the particular subject. The computer-assisted method of the present invention enables interaction between human beings and computers and other Internet connected devices, and other services offered directly or indirectly through the Internet or internet connected devices more natural and also enables the computers and other Internet connected devices to perceive and respond to human non-verbal communication i.e. emotions of the subject and other multi dimensional dynamic profile states of the subject obtained from the activities of the subject or the people or entities associated with the subject. An application of the present method is that it improves the business analytics for providing targeted content for each subject or user of an internet connected devices or internet based service by improving the robustness and accuracy of the emotional recognition system using multimodal emotional recognition including multimodal emotional states from face and speech, gender and age estimation and body language features of the subject and using the multi dimensional dynamic profile states of the subject.

The comprehensive state of the subject includes variety of emotional and profile state information. The comprehensive state includes the detectable emotional states and profile states of the subject. The emotional states of the subject include facial feature, speech feature, body language feature, subject's activity feature, or a combination of one or more of the plurality of features. The profile state information of the subject includes all the information associated with the subject collected through Internet, which includes social media interactions, facial recognition, global and local events and geopolitical events, financial information, brand affinity, personal preferences, scene analysis, age and gender estimation, professional history, purchase history, navigation traces on Internet, location history, weather data, event calendar, pre-event and post event status, medical health data, email, subject's family information, subject's psychological information, subject's social connections information, subject's contacts' information, subject's wearable information, subject's physical appearance, subject's crime history, academics data, subject's surroundings information, any other information directly or indirectly related to the subject and accessible through the Internet and any other data generated and/or consumed by the subject.

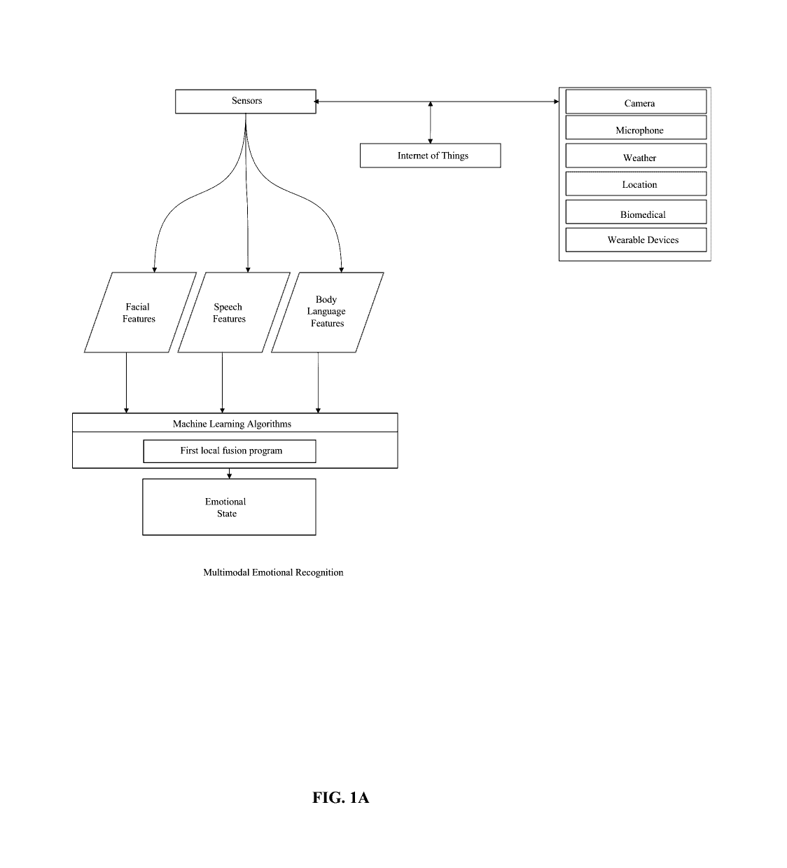

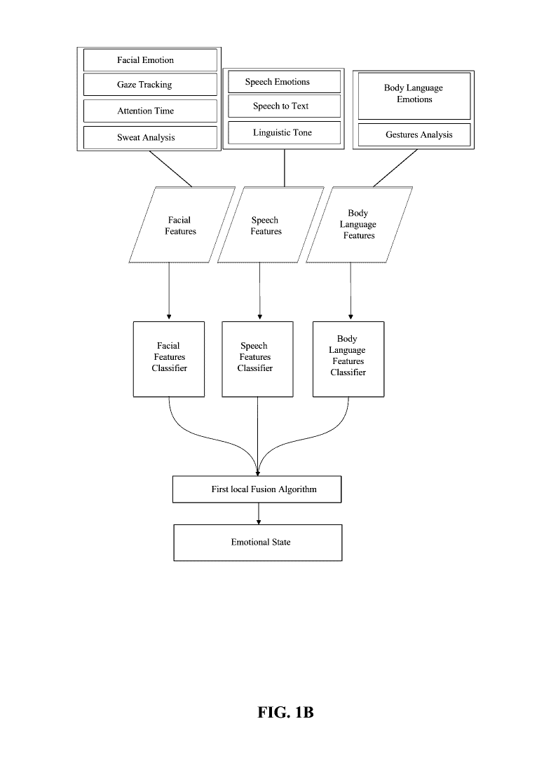

FIG. 1 to FIG. 2 illustrates a block diagram showing the steps for obtaining at least one comprehensive state of a subject for the purpose of providing targeted contents and services for the subject. The method for determining the comprehensive state of the subject includes the step of performing the multimodal emotion recognition to determine a deep emotional state of the subject and obtaining an advanced multi dimensional dynamic profile state of the subject. The multimodal emotional information of the subject and the multi dimensional profile state of the subject is processed together to provide targeted contents to the subject. In a preferred embodiment, according to FIG. 1A and FIG. 1B, the method of performing the comprehensive multimodal emotion recognition of the subject comprises the steps of monitoring multiple features of the subject such as, but not limited to, at least one facial feature, at least one speech feature and at least one body language feature of the subject or a combination of one or more of the above features using one or more sensors and other data collection means. The sensors includes camera, microphone, weather sensor, location sensor, biomedical, sensors associated with (IoT) and other sensors associated with multiple wearable devices including but not limited to Smartwatches, smart fitness bands etc. These sensors may form a part of a computer system or an Internet connected device and for analyzing the dynamic and real time emotional states of the subject. The sensors collect the facial features, speech features and body language features of the subject and the information is fed to a computer system running a machine language application for determining the real time emotional state of the subject. The facial feature analysis of the subject includes continuous monitoring of a plurality of facial emotion, gaze tracking, attention time and sweats analysis. The speech feature analysis of the subject includes continuous monitoring of speech emotions, speech to text and linguistic tone of the subject. The body language features analysis of the subject includes continuous monitoring of body language emotions and analysis of gestures made by the subject in response to content such as, but not limited to, advertisements displayed on a digital signage or an interne connected device. The collected facial features, speech features and body language features of the subject are then classified based on instructions of the machine learning program, which is executed using at least one processor of a computer system. The machine-learning program running in the computer system includes a first local fusion program having a facial feature classifier module, a speech feature classifier module and a body language feature classifier module. The facial feature classifier module classifies the facial features of the subject corresponding to different emotions of the subject including happiness, sadness, angriness, depression, frustration, agitation, fear, hate, dislike, excitement, etc. Whereas the speech feature classifier module classifies the speech features of the subject corresponding to different speech emotions such as, but not limited to, happiness, angry, excitement, like dislike, etc. The body language classifier module classifies the body language of the subject corresponding to different emotions. Thereby an accurate determination of the emotional states of the subject can be obtained using each of the classifier modules associated with the machine learning application. The first local fusion program running on the computer system combines the emotional states of the subject obtained using each of the classifier modules to obtain the multimodal deep emotional state of the subject.

The preferred embodiment of the present invention further includes the step of obtaining the advanced dynamic multi dimensional profile state of the subject for the purpose of deriving the comprehensive state of the subject. FIG. 2 illustrates block diagram showing the steps for obtaining the advanced dynamic multi dimensional dynamic profile state of the subject. The method to obtain the advanced multi dimensional dynamic profile state of the subject comprises the steps of collecting profile information associated with the subject from multiple homogeneous and heterogeneous sources and sensors including, but not limited to, social media interactions, facial recognition, global and local events and geopolitical events, financial information including credit score, brand affinity or brand recognition, personal preferences, scene analysis, age and gender estimation, professional history, purchase history, navigation traces on web, location history, weather data, event calendar, pre-event and post event status, medical health data, email, subject's family information, subject's psychological information, subject's social connections information, subject's contacts' information, subject's wearable information, subject's physical appearance, subject's crime history, academics data, subject's surroundings information, any other information directly or indirectly related to the subject and accessible through the Internet and any other data generated and consumed by the subject. The dynamic profile state information including brand affinity comprises logo detection for obtaining the advanced multi dimensional dynamic profile state of the subject and scene analysis comprises scene recognition, environment objects analysis, environment light analysis, environment audio and crowd analysis. The profile state information such as the age and gender estimation associates facial recognition information with the age and gender of the subject for accurate determination of the at least one deep emotional state of the subject. The instructions of the second local fusion program of the machine learning application configured run on the computer system integrates the subject's profile state information obtained from the above said homogeneous and heterogeneous sources and sensors and processes the profile state information based on the instructions of the machine learning program. The multidimensional dynamic profile state information obtained by processing the collected profile information using the multiple homogeneous and heterogeneous sources and sensors is then combined with the deep emotional state of the subject to determined the comprehensive state of the subject. The comprehensive state of the subject thus determined is then used to update the business analytics thereby providing targeted contents and services to the subject.

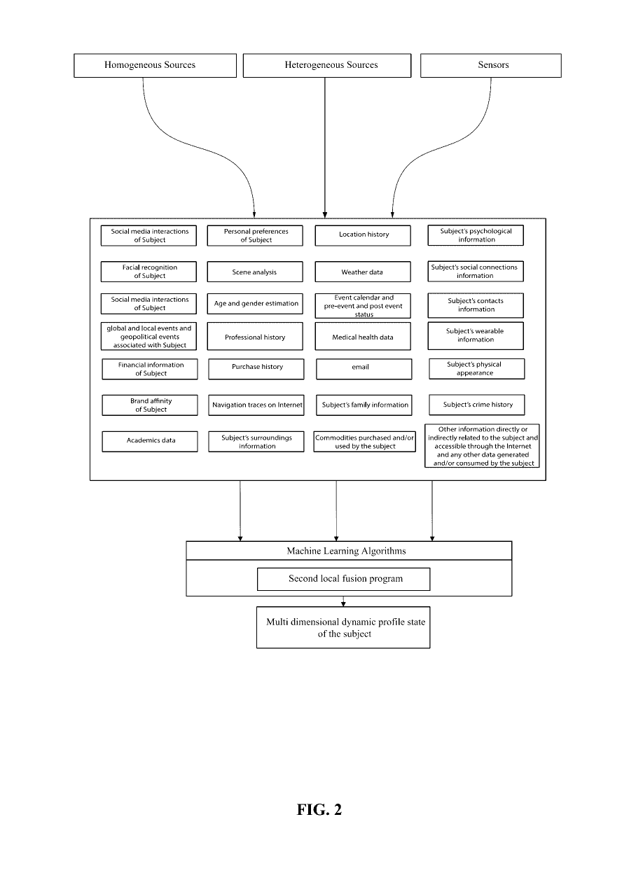

FIG. 3 shows the block diagram of the machines learning program for processing the multidimensional dynamic profile state information and the multimodal deep emotional states of the subject. The machines learning program includes the first local fusion program and the second local fusion program. The first local fusion program includes the facial feature classifier module, speech feature classifier module and the body language feature classifier module in addition to other activities and emotional recognition modules. The facial feature classifier module classifies the facial features of the subject corresponding to different emotions, the speech feature classifier module classifies the speech features of the subject corresponding to different speech emotions, the body language classifier module classifies the body language of the subject corresponding to different emotions. The first local fusion program combines the emotional states of the subject obtained using each of the classifier modules to obtain the multimodal deep emotional state of the subject. The second local fusion program of the machine learning application integrates the dynamic profile state information obtained from the homogeneous and heterogeneous sources and sensors and processes the subject's profile state information based on the instructions of the machine-learning program. A global fusion program forming a part of the machine learning program combines the multimodal emotion recognition information obtained from the multimodal emotion recognition process and the multi dimensional dynamic profile state information of the subject together to obtain the comprehensive state of the subject.

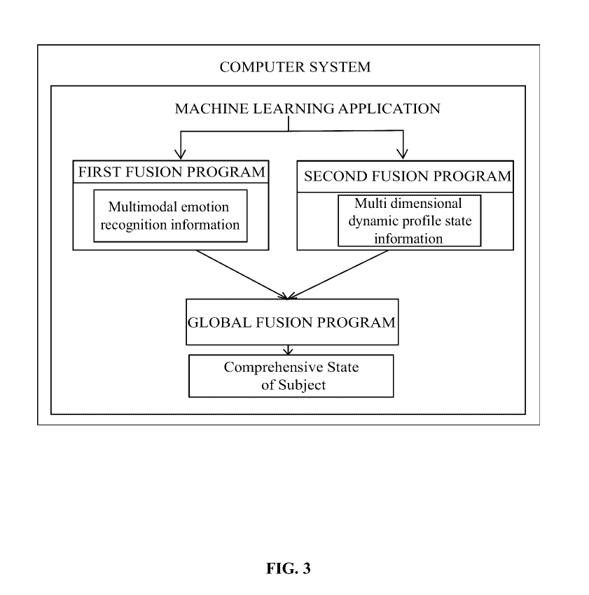

The embodiments of the present invention utilizes the deep emotional states of the subject and the subject's multidimensional dynamic profile state information for providing targeted advertisements and other business services to the subject through a variety of connected devices including, but not limited to, computer systems, Smartphones, Tablets, Smart TV, Smart wearable devices and other portable wireless connected electronic devices. FIG. 4 illustrates a block diagram showing a computer-implemented system (100) for obtaining the comprehensive state of the subject for the purpose of providing targeted advertisements and other business services to the subject. The computer-implemented system (100) for providing targeted advertisements and other business services to the subject comprises multiple connected devices (102), multiple sensors (104) for detecting subject's features including facial features, speech features, body language features etc. The subject's activities with the connected devices (102) are continuously monitored and the information is send to the central server or a cloud based processing engine over a communication network (106) such as Internet. The machine-learning program associated with the cloud based processing engine processes the information and determines the comprehensive state of the subject, which includes the emotional state and the profile state of the subject. The collected emotional state and the profile state information is then associated with appropriate business context such as, but not limited to, Advertisement, Surveillance and Monitoring, Research and Development, Automobile, Consumer Retail, Market Research, TV & Film, Social Media, Gaming, Education, Robotics, Medical, etc. The selected business context based on the emotional state and the profile states of the subject are then analyzed using a business analytics engine and suitable advertisements and business services are selected from the business database. These targeted advertisements and business services for the subject is then transmitted through the communication network (106) and made accessible to the subject using the connected devices (102) such as, but not limited to, computer systems, Smartphones, Tablets, Smart TV, Smart wearable devices and other portable wireless connected electronic devices. A privacy protection module secures the personal information of each subject and prevents unauthorized access of the information.

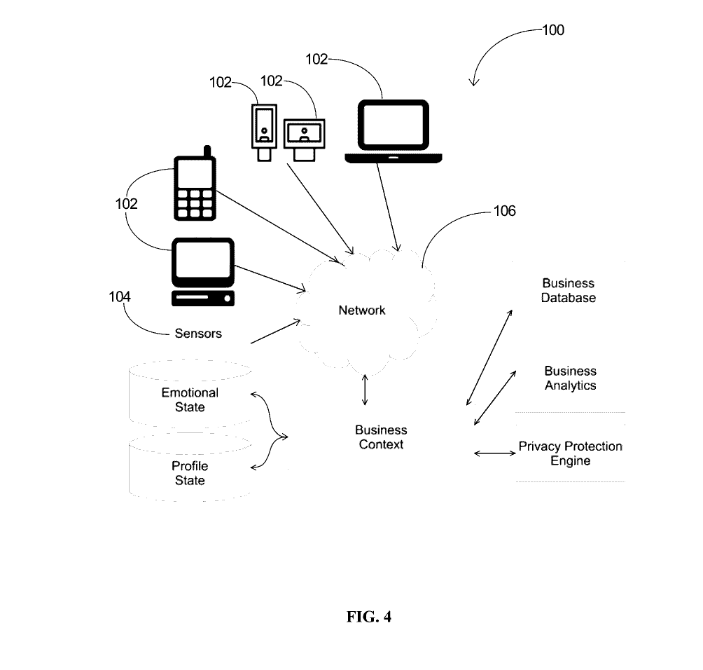

FIG. 5 illustrates a flow diagram showing a computer-implemented system (100) for obtaining the targeted advertisements and business services for the subject based on the emotional state and the profile states of the subject. The deep emotional states of the subject for each business context and the subject's multidimensional dynamic profile state information are processed for providing targeted advertisements and business services for the subject. The feedbacks in form of emotional state and the profile states of the subject for each advertisements and business services presented to the subject are collected and reported to the business analytics program, which further analyzes the subject's response to each targeted advertisements and business services. An application of the method of the present invention is that the comprehensive state obtained for each subject can be used to provide dynamic tailored advertisements and business services for the subject.

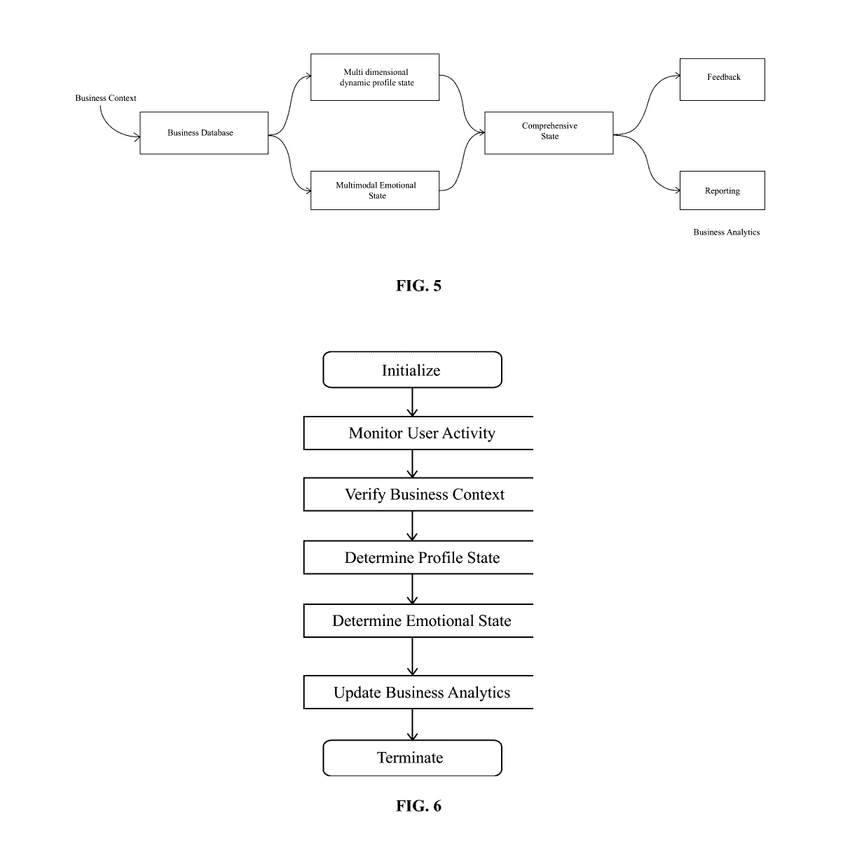

FIG. 6 illustrates a flowchart showing the method for providing the targeted advertisements and business services by continuously updating the business analytics based on the comprehensive state of the subject. The method of providing the targeted advertisements and business services by continuously updating the business analytics based on the comprehensive state of the subject comprises the steps of monitoring multiple activities of the subject in response to a content displayed or presented on the at least one connected device (102). The activities of the subject with the at least one connected device includes keyboard keystroke dynamics, mouse movements, touch screen interactions, social media and geopolitical activities of the subject. The method then verifies the business context for a particular activity performed by the subject. The activities of the subject with the at least one connected device may indicate the at least one deep emotional state of the subject. Now the emotional state and the profile state of the subject is determined as described in the above paragraphs i.e. from the features of the subject such as, but not limited to, at least one facial feature, at least one speech feature and at least one body language feature of the subject and from multiple homogeneous and heterogeneous sources. Thus for the comprehensive state of the subject including the emotional state and the profile state of the subject for each business context is obtained and based on the comprehensive state of the subject, the advertisements and business services can be dynamically updated.

The comprehensive state of the subject can be utilized in a plurality of applications, but not limited to, advertisements, and for other business analytics and service recommendation applications. For example, embodiments of the present invention allow the business service providers and other advertisers to provide target advertisements to subjects based on the comprehensive state of the subject, which comprises the deep emotional state and the profile state of the subject. The type of advertisement or business service is selected from a business database and presented to the connected device such as a computer or portable electronic device of the subject. The business service providers and advertisers provide continuously monitors the responses by the subject to dynamically changing the advertisements provided to the subject. This allows the advertisement service providers to determine the deep emotional state and the profile state of the subject in response to the content and would be able to provide advertisement with best monetization value. The method of the present invention can be employed in a variety of advertising means including, but not limited to, Digital Signage, VoIP, Smart Phones, Smart Television, Customer Care, Banking, etc. For instance, the present method turns digital screens into intelligent machines, allowing digital billboard companies, advertisers, shopping centers and others to analyze and collect information e.g. age, gender, facial features, body language, etc. and thereby can collect the emotional state of the subject in response to an advertisement or displayed content. This allows the digital signage companies to provide targeted advertisements based on the responses of each type of subjects, such as based on age, gender, etc.

Another example for the use of comprehensive state of the subject is for VoIP based applications such as video chatting applications, The comprehensive state of the present method can analyze and collect information e.g. age, eye gaze tracking, gender, head pose, facial mood, clothing color, attention time, location, body gesture, speech to text, speech emotion, etc., and can also monitor the activities of the subject such as keyboard keystroke dynamics, mouse movements, touch screen interactions, etc., and can provide targeted advertisements to the subject.

Another example for the use of comprehensive state of the subject is for smart wearable devices, portable electronic devices such as, but not limited to, smartphone, tablets, smart recording and camera devices, etc., and other smart devices such as smart TV, etc. to provide customized contents including advertisements.

Another example for the use of comprehensive state of the subject is for customer care applications. The comprehensive state can be utilized to Scan through all ongoing calls, capture customer's emotional profile in real time or offline, get real time alert when your customer is unhappy or angry or not having interest, monitor work related stress level of your agents, etc. Thus the customer services providers can decide suitable approach to each subject based on the emotional and the profile state of each subject.

Another example for the use of comprehensive state of the subject is in banking services, through which banks can discover how their customer feel about wealth, engaging them in personalized sessions to help understand their emotional state. Banks can use transaction time at ATM's and push specific advertisements or marketing programs based on the comprehensive state of the subject.

The comprehensive state of the subject obtained using the present method can further be employed in many industries including Retail Industry for targeted ads, coupons, healthcare for hospital and pain management, online education for analyze student emotions, security for monitor ugly behaviors at public places, medical for autism, Asperger, emotional hearing aid, auto industry for improve driver safety, lifestyle, music for play music based on emotions, robots for understand human emotions, other b2c applications, face, avatar personalization, human resources for interview, body language identification etc. Hence the present method analyzes and collecting emotional and profile state information of the subject in response to a content, and adjusts the information or media or provided content on the digital screen, computer, portable device, etc., to the subject's mood, gender, age and interest accordingly.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

Although the embodiments herein are described with various specific embodiments, it will be obvious for a person skilled in the art to practice the invention with modifications. However, all such modifications are deemed to be within the scope of the claims.

1. A method for obtaining a comprehensive state of a subject comprising:
obtaining emotional state of the subject by at least one multimodal emotion recognition:
wherein the method of performing the multimodal emotion recognition of the subject comprises:
monitoring a plurality of features of the subject using a plurality of sensors, wherein the plurality of features includes at least one facial feature, at least one speech feature and at least one body language feature of the subject or a combination of one or more of the plurality of features;
classifying the plurality of features of the subject based on a plurality of instructions of at least one machine learning program executed using at least one processor; and
determining at least one emotional state of the subject, by processing information received after classification of the plurality of features, through a first local fusion program using the processor; and
obtaining a multi dimensional dynamic profile state of the subject, wherein the method to obtain the multi dimensional dynamic profile state of the subject comprises:
collecting a plurality of profile state information associated with the subject from a plurality of homogeneous and heterogeneous sources and sensors including social media interactions, facial recognition, global and local events and geopolitical events, financial information, brand affinity, personal preferences, scene analysis, age and gender estimation, professional history, purchase history, navigation traces on Internet, location history, weather data, event calendar, pre-event and post event status, medical health data, email, subject's family information, subject's psychological information, subject's social connections information, subject's contacts' information, subject's wearable information, subject's physical appearance, subject's crime history, academics data, subject's surroundings information, any other commodities purchased and/or used by the subject, any other information directly or indirectly related to the subject and accessible through the Internet and any other data generated and/or consumed by the subject;
integrating the plurality of profile state information from the plurality of homogeneous and heterogeneous sources and sensors using a second local fusion program;
processing the plurality of profile state information associated with the subject based on a plurality of instructions of the second local fusion program using the at least one processor; and
deriving the multi dimensional dynamic profile state associated with the subject based on the plurality of profile state information processed using the machine learning program; and
processing the multimodal emotion recognition information and the multi dimensional dynamic profile state information of the subject together using a global fusion program to obtain the comprehensive state of the subject.

2. The method of claim 1 wherein performing the multimodal emotion recognition of the subject further includes monitoring a plurality of activities of the subject with at least one connected device.

3. The method of claim 2 wherein the plurality of activities of the subject includes keyboard keystroke dynamics, mouse movements, touch screen interactions, social media and geopolitical activities of the subject and other interactions of the subject with the connected device,
wherein the plurality of activities of the subject with the connected device indicate the emotional state of the subject.

4. The method of claim 1 wherein monitoring the at least one facial feature of the subject includes continuous monitoring of a plurality of facial emotion, gaze tracking, attention time and sweat analysis, any other detectable changes, expressions, gestures and any change in form or dimension of one or more parts of the face of the subject.

5. The method of claim 1 wherein monitoring the at least one speech feature of the subject includes continuous monitoring of speech emotions, speech to text, linguistic tone of the subject and any detectable changes or expressions produced in form of sounds by the subject.

6. The method of claim 1 wherein monitoring the body language features of the subject includes continuous monitoring of body language and analysis of gestures, movements and other postures representing the attitudes and feelings of the subject.

7. The method of claim 1 wherein the profile state information including scene analysis comprises scene recognition, environment objects analysis, environment light analysis, environment audio and crowd analysis.

8. The method of claim 1 wherein the profile state information including age and gender estimation associates facial recognition information with the age and gender of the subject for accurate determination of the emotional state of the subject.

9. The method of claim 1 wherein the at least one comprehensive state of the subject is used for dynamically updating the business analytics for providing a plurality of tailored contents to the subject,
wherein a method of dynamically updating the business analytics comprises:
monitoring the plurality of activities of the subject in response to the at least one content;
verifying business context associated with the plurality of activities of the subject in response to the at least one content;
determining the multi dimensional dynamic profile state information of the subject;
determining the emotional states of the subject; and
updating the business analytics to present the tailored contents to the subject.

10. The method of claim 1 wherein the tailored contents to the subject include a plurality of tailored advertisements and business services to the subject.

11. The method of claim 1 wherein the comprehensive state of the subject is derived from the at least one multimodal emotion recognition information and at least one multi dimensional dynamic profile state information of the subject.

12. The method of claim 9 wherein the plurality of activities of the subject comprises facial emotion, gaze tracking, attention time, sweats analysis, head pose, body gesture, speech to text, speech emotion, and other features in response to the at least one content.

13. The method of claim 1 wherein the machine learning program includes the first local fusion program, the second local fusion program and the global fusion program,
wherein the first local fusion program is used for deriving the multimodal emotion recognition information of the subject by combining a plurality of emotional states of the subject,
wherein the second local fusion program is used for deriving the multi dimensional dynamic profile state associated with the subject by combining a plurality of profile state information associated with the subject,
wherein the global fusion program is used for combining the multimodal emotion recognition information and the multi dimensional dynamic profile state information of the subject to obtain the comprehensive state of the subject.
